(19) United States
(12) Patent Application Publication
(10) Pub. No.: US 2014/0181379 A1
(43) Pub. Date: Jun. 26, 2014

(54) File Reading Method, Storage Device And Electronic Device

(71) Applicants: Lenovo (Beijing) Co., Ltd., Beijing (CN); Beijing Lenovo Software Ltd., Beijing (CN)

(72) Inventors: Qi Guo, Beijing (CN); Jianwei Lu, Beijing (CN); Huijuan Guan, Beijing (CN); Shaohua Huang, Beijing (CN); Hongwei Li, Beijing (CN)

(73) Assignees: Lenovo (Beijing) Co., Ltd., Beijing (CN); Beijing Lenovo Software Ltd., Beijing (CN)

(21) Appl. No.: 14/135,966

(22) Filed: Dec. 20, 2013

(30) Foreign Application Priority Data
Dec. 21, 2012 (CN) 201210564732.4

(51) Int. Cl. G06F 12/02

(52) U.S. Cl. CPC G06F 12/0246
USPC 711/103

(57) ABSTRACT

A file reading method, storage device and electronic device are described. The file reading method is applied to an electronic device that includes a nonvolatile storage device as an internal storage device. The method includes determining a specific file in the electronic device as a hotspot file according to a predetermined condition; copying the determined hotspot file to the non-volatile storage device; and directly addressing the non-volatile storage device and reading the hotspot file from the nonvolatile storage device when receiving a request for reading the hotspot file.

This application claims priority to Chinese patent application No. 201210564732.4 filed on Dec. 21, 2012, the entire contents of which are incorporated herein by reference.

### BACKGROUND

The present disclosure relates to the field of electronic devices, and more particularly, to a file reading method, a storage device and an electronic device.

Nowadays, in the electronic device adopting the embedded system, devices such as raw flash, SD Card (Secure Digital storage device card), mmc (multimedia card) and so on are usually used as external storage devices, which are nonvolatile storage devices for storing data that need to be reserved for a long time.

On the other hand, currently in the electronic devices, internal storage device generally used is volatile storage device. After the electronic device is powered off, the data read into the internal storage device during the operation of the electronic device will be lost

Affected by the characteristics of the devices, the accessing rate of the external storage device is relatively slow. Furthermore, during the operation, the electronic device often needs to read specific files from external storage device to internal storage device for buffering, so as to facilitate specific operations of the electronic device. Since the electronic device needs to re-read the specific file from external storage device each time the electronic device is rebooted, a relatively long time is required each time, which results in a slower operating speed of the electronic device.

For this reason, it is desirable to provide a file reading method, a storage device and an electronic device which can effectively read specific files, so as to increase the operating speed of the electronic device.

### SUMMARY

According to one embodiment of the present disclosure, a file reading method is provided, which is applied to the electronic devices. The electronic device includes a nonvolatile storage device as an internal storage device, and the method comprises the following steps: according to a predetermined condition, determining a specific file in the electronic device as hotspot file; copying the determined hotspot file to the non-volatile storage device; and when receiving a request for reading a hotspot file, directly addressing the non-volatile storage device and reading the hotspot file from the nonvolatile storage device.

Alternatively, receiving a request for reading the hotspot file further comprises making the page cache pointer of a node directly point to the nonvolatile storage device address space.

Alternatively, according to a predetermined condition, determining a specific file in the electronic device as hotspot file comprises: determining whether the specific file is hotspot file according to the file accessing frequency, wherein when the file accessing frequency is high, the file is determined to be hotspot file.

Alternatively, according to a predetermined condition, determining a specific file in the electronic device as hotspot file comprises: determining the hotspot file according to the file type, wherein the file is determined to be the hotspot file when the file is a system file.

Alternatively, the file reading method further comprises: when the electronic device is rebooted, directly reading the system files stored as hotspot files in the non-volatile storage device so as to start quickly.

Alternatively, the nonvolatile storage device is connected to the main board of the electronic device according to the double data rate DDR mode.

Alternatively, the nonvolatile storage device and the volatile storage device used as internal storage device in the electronic device are integrally formed.

Alternatively, specific files in the electronic device are maintained in the external storage device connected to the electronic device.

According to another embodiment of the present disclosure, a storage device is provided, which comprises:

A first storage device including nonvolatile storage device configured to store the hotspot files, wherein, when receiving the request for reading a hotspot file in the storage device, the nonvolatile storage device is directly addressed and the hotspot file is read from the non-volatile storage device.

Alternatively, the storage device further includes a second storage device including a volatile storage device, wherein the first storage device and the second storage device are integrally formed.

According to another embodiment, an electronic device is provided, comprising: a first storage unit, including nonvolatile storage device and configured to store the hotspot files of the electronic device; a determining unit, configured to determine a specific file in the electronic device as hotspot file according to predetermined conditions; a copying unit, configured to copy the determined hotspot file to the nonvolatile storage unit; and a control unit, configured to directly address the nonvolatile storage device and read the hotspot file from the nonvolatile storage device when receiving the request for reading the hotspot file.

Alternatively, the electronic device further comprises a second storage unit including a volatile storage device, wherein the first storage unit and the second storage unit are integrally formed.

Therefore, according to the file reading method, storage device and electronic device according to the embodiment of the present disclosure, specific files can be effectively read, thereby increasing the operating speed of the electronic device.

### BRIEF DESCRIPTION OF THE DRAWINGS

FIG. 1 is a flow chart of the file reading method according to the first embodiment of the present disclosure;

FIG. 2 is a functional configuration block diagram of the storage device according to the second embodiment of the present disclosure;

FIG. 3 is a functional configuration block diagram of the storage device according to the third embodiment of the present disclosure;

FIG. 4 is a functional configuration block diagram of the electronic device according to the fourth embodiment of the present disclosure;

FIG. 5 is a functional configuration block diagram of the electronic device according to the fifth embodiment of the present disclosure.

### DETAILED DESCRIPTION

Hereinafter, embodiments of the present disclosure will be described with reference to the accompanying figures.

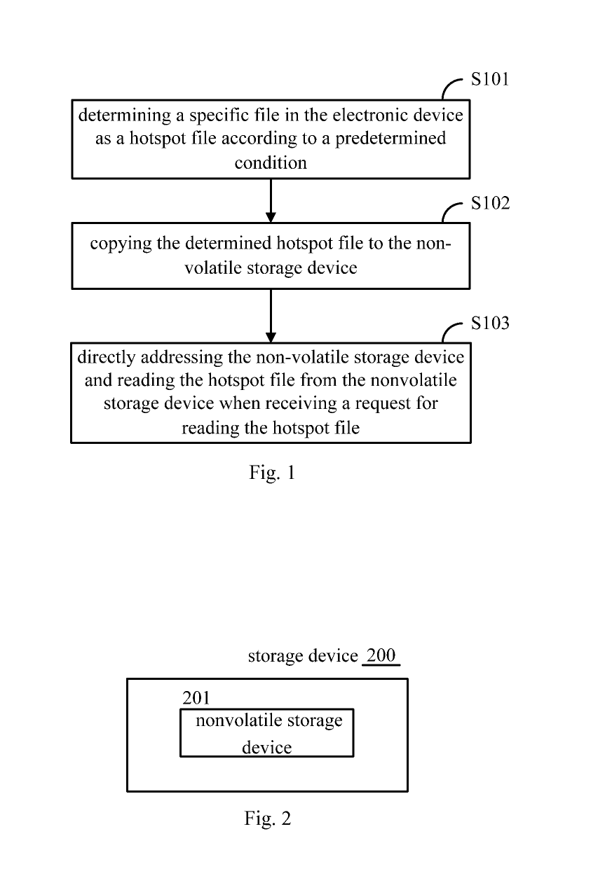

FIG. 1 is a flowchart of the file reading method 100 according to the first embodiment of the present disclosure.

The file reading method according to the first embodiment of the present disclosure is applied to electronic devices. The electronic device can be any electronic device, such as a desktop computer, a tablet computer, a smart phone, a personal digital assistant and so on. Furthermore, the electronic device includes nonvolatile storage device and volatile storage device as internal storage device. For example, as known by those skilled in the art, the volatile storage device used as memory are usually connected to the main board of the electronic device by means of SDRAM, double data rate DDR, DDR2, etc. Therefore, when used as memory, the nonvolatile storage device is also connected to the main board of the electronic device by means of DDR, DDR2, etc. In this case, this part of memory addresses is protected individually in the kernel of the operating system.

On the other hand, as known by those skilled in the art, when the nonvolatile storage device is used as an external storage device, it can be connected to the main board of the electronic device by means of ordinary storage device, such as USB, SATA etc.

Specifically, the method 100 comprises:

At step S101, according to the predetermined condition, a specific file in the electronic device is determined as a hotspot file.

In this step, for example, the user behavior during the operation of electronic devices is analyzed, and whether the file is a hotspot file is determined according to the file accessing frequency. For example, when the file accessing frequency is high, the file is determined to be a hotspot file. For example, during the using period of a user after the electronic is rebooted for five times, when the same song is listened for three times, the song can be determined as a hotspot file.

That is, in the process of determining a hotspot file, through certain learning process, by analyzing the behavior of the user, such as the frequency of accessing to a specific file, the time length of using and so on, which files are the files with high accessing rate are determined and the files with high accessing rate are defined as hotspot files.

In another embodiment, whether the file is a hotspot file can be determined according to the type of the file. For example, when a file is a system file, the file is determined as a hotspot file. For example, the files that must be accessed at booting time can be directly determined as hotspot files.

At step S102, the determined hotspot file is copied to the non-volatile storage device.

In this step, since the hotspot file is a file with high accessing rate, that is, the file that is the frequently accessed, the determined hotspot file can be copied to the nonvolatile storage device used as part of the memory of the electronic device.

At step S103, when receiving a request for reading the hotspot file, the non-volatile storage device is directly addressed and the hotspot file is read from the nonvolatile storage device.

In this step, when a request for reading the hotspot file is received in the operating system, for example, when various applications requires to access the hotspot file, the operating system will intercept the read request and the read request is addressed to the nonvolatile storage device which stores the hotspot file and the hotspot file is read from the nonvolatile storage device.

Specifically, according to the prior art, if the file is stored in the external storage device, when the operating system reads the file, files in the external storage device are usually required to be mapped to the internal storage device so as to increase the access speed to the external storage device. The size of a file mapping is one page, which is typically 4 K bytes. That is, when receiving a request for reading a file, the operating system accesses to the page cache through the file system. Then according to the read request, the file stored in the external storage device is mapped to the page cache with the page as a unit. At this time, when the operating system accesses the file, two stages are required, which includes mapping it from the external storage device to the internal storage device and then reading it from the internal storage device. That is time-consuming. Therefore, for the files that are frequently accessed (for example, the system files), if the two stages are required, the operation speed will be significantly slower.

Therefore, in the file reading method according to the first embodiment of the present disclosure, since the hotspot files required to be accessed frequently are already stored in the nonvolatile storage device, when the operating system accesses a hotspot file, the non-volatile storage device as part of the of the internal storage device can be directly addressed and the hotspot file can be read from the nonvolatile storage device. That is, for the hotspot files, only one stage for reading the file from the internal storage device is required. Therefore, the operating speed of the electronic device can be significantly improved.

Specifically, the operating system makes the page cache pointer of the node directly point to the address space of the nonvolatile storage device through the page cache pointer of the index node of the file. Then, when the system accesses the file, it only needs to access the page cache layer before it returns, which greatly reducing the operating processes of the operating system kernel, thereby improving the reading performance of the file.

Further, when system files are stored in the non-volatile storage device as hotspot files, when the electronic device is rebooted, the system files stored in the non-volatile storage device as hotspot files can be directly accessed so as to be quickly started. In this case, since the operating system does not need to read the system file from external storage device in startup process, such as the hard disk, the startup speed can be greatly increased.

It should be noted that the case where the nonvolatile storage device and the volatile storage device as memory are provided separately are described above. However, the nonvolatile storage device and the volatile storage device may also be integrally formed.

That is, the nonvolatile storage device and the volatile storage device may be disposed on the same substrate, thereby integrally forming a single internal storage device. At this time, the single internal storage device formed this way can uniformly assign the address space in the operating system, and distinguish the non-volatile storage device from volatile storage device according address space.

Therefore, according to the file reading method of the first embodiment of the present disclosure, the specific file can be effectively read so as to increase the operating speed of the electronic device.

### Second Embodiment

Next, the functional configuration of the storage device according to the second embodiment of the present disclosure is described with reference to FIG. 2. FIG. 2 is a functional configuration block diagram of the storage device 200 according to the second embodiment of the present disclosure.

The storage device 200 according to a second embodiment of the present disclosure comprises a nonvolatile storage device 201.

The nonvolatile storage device 201 is configured to store hotspot files, wherein, when receiving the request for reading a hotspot file in the storage device 200, the nonvolatile storage device 201 is directly addressed and the hotspot file is read from the non-volatile storage device.

The storage device 200 is connected by means of DDR in the electronic device, for example, so that it can act as the memory of the electronic device. Further, since the storage device 200 includes nonvolatile storage device 201, it can be used to store hotspot files.

Similar to the first embodiment above, for example, the hotspot file can be determined according to the using frequency or type of the file.

Therefore, when receiving the request for reading a hotspot file in the storage device 200, the operating system can directly address the nonvolatile storage device 201 as part of the internal storage device and read the hotspot file from the nonvolatile storage device 201. That is, for the hotspot files, only one stage for reading the file from the internal storage device is required. Therefore, the operating speed of the electronic device can be significantly improved.

Therefore, according to the storage device of the second embodiment of the present disclosure, specific files can be effectively read, thereby increasing the operating speed of the electronic device.

### Third Embodiment

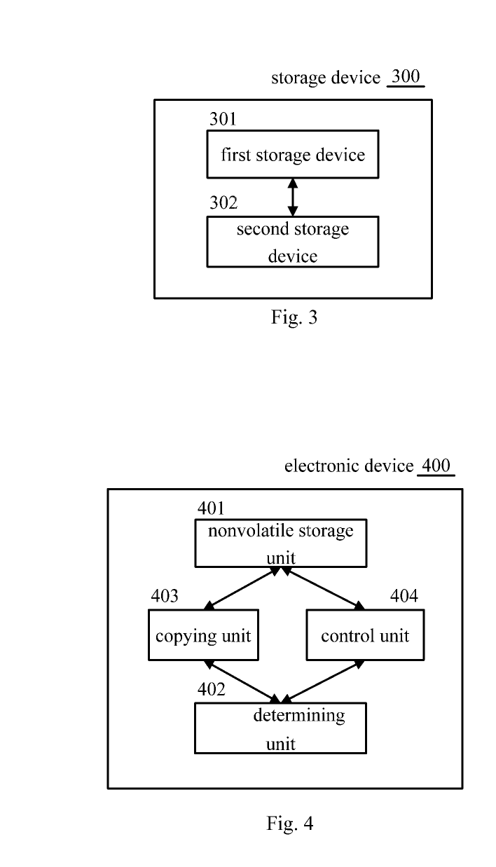

Next, the functional configuration of the storage device according to the third embodiment of the present disclosure is described with reference to FIG. 3. FIG. 3 is a functional configuration block diagram of the storage device 300 according to the third embodiment of the present disclosure.

The storage device 300 according to the third embodiment of the present disclosure comprises a first storage device 301 and a second storage device 302.

The first storage device 301 includes nonvolatile storage device and is configured to store the hotspot files, wherein, when receiving the request for reading a hotspot file in the storage device 300, the nonvolatile storage device is directly addressed and the hotspot file is read from the non-volatile storage device.

The second storage device 302 includes volatile storage device, wherein the first storage device 301 and second storage device 302 are integrally formed.

In the storage device 300, the first storage device 301 as a nonvolatile storage device and the second storage device 302 as volatile storage device are, for example, arranged on the same substrate and are connected to the electronic device, for example, by means of DDR, so that a single internal storage device can be formed integrally. At this time, the single internal storage device thus formed can assign the storage device address space uniformly in the operating system, and the non-volatile storage device can be distinguished from the volatile storage device according to the address space.

Therefore, when receiving the request for reading a hotspot file in the storage device 300, the operating system can directly address the nonvolatile storage device 301 as part of the internal storage device and read the hotspot file from the nonvolatile storage device. That is, for the hotspot files, only one stage for reading the file from the internal storage device is required. Therefore, the operating speed of the electronic device can be significantly improved.

Therefore, according to the storage device of the third embodiment of the present disclosure, specific files can be effectively read, thereby increasing the operating speed of the electronic device.

### Fourth Embodiment

Next, the functional configuration of a fourth embodiment according to the present disclosure will be described with reference to FIG. 4. FIG. 4 is a functional block diagram of the electronic device 400 according to a fourth embodiment of the present disclosure.

The electronic device 400 according to the fourth embodiment of the present disclosure comprises a nonvolatile storage unit 401, a determining unit 402, a copying unit 403 and a control unit 404.

The nonvolatile storage unit 401 is configured to store the hotspot file of the electronic device file 400.

The determining unit 402 is configured to determine a specific file in the electronic device 400 as a hotspot file according to predetermined conditions.

The copying unit 403 is configured to copy the determined hotspot file to the nonvolatile storage unit 401; and

The control unit 404 is configured to directly address the nonvolatile storage device 401 and read a hotspot file from the nonvolatile storage device 401 when receiving the request for reading the hotspot file.

In the electronic device 400, the nonvolatile storage unit 401, for example, is connected to the electronic device 400 by means of DDR, so as to act as a memory of the electronic device, and can be used to store hotspot files.

The determining unit 402 determines a specific file in the electronic device 400 to be a hotspot file according to predetermined conditions. The same as the first embodiment above, the hotspot file, for example, can be determined according to the using frequency or type of the file.

The copying unit 403 copies the determined hotspot file to the nonvolatile storage unit 401.

When the control unit 404 receives a request for reading a hotspot file, the nonvolatile storage device as part of the internal storage device can be directly addressed and the hotspot file can be read from the nonvolatile storage device 401. That is, for the hotspot files, only one stage for reading the file from the internal storage device is required. Therefore, the operating speed of the electronic device can be significantly improved.

Further, the control unit 404 makes the page cache pointer of the node directly point to the nonvolatile storage device address space when receiving the request for reading the hotspot file.

Furthermore, the determination unit 403, for example, can also determine whether a file is a hotspot file according to the type of the file, wherein, when the file is a system file, the file can be determined as a hotspot file.

Furthermore, the control unit 404 can directly read the system files as hotspot files in the nonvolatile storage device when the electronic device is rebooted, so that it can start quickly.

In the present embodiment, the nonvolatile storage device is connected to the main board of the electronic device by means of double data rate DDR, so as to act as an internal storage device of the electronic device.

Accordingly, the electronic device according to the fourth embodiment of the present disclosure, it is possible to effectively read specific files, so as to increase the operating speed of the electronic device.

### Fifth Embodiment

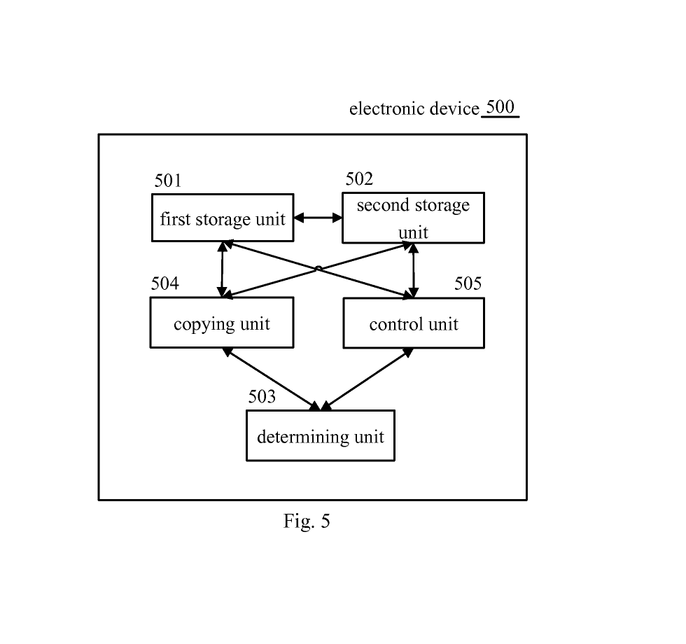

Next, the functional configuration of the storage device according to the fifth embodiment of the present disclosure is described with reference to FIG. 5. FIG. 5 is a functional configuration block diagram of the electronic device according to the fifth embodiment of the present disclosure.

The electronic device 500 according to the fifth embodiment of the present disclosure comprises a first storage unit 501, a second storage unit 502, a determining unit 503, a copying unit 504 and a control unit 505.

The first storage unit 501 includes nonvolatile storage device and is configured to store the hotspot files of the electronic device.

The second storage unit 502 includes volatile storage device;

The determining unit 503 is configured to determine a specific file in the electronic device 500 as a hotspot file according to predetermined conditions;

A copying unit 504 is configured to copy the determined hotspot file to the nonvolatile storage unit; and

A control unit 505 is configured to directly address the nonvolatile storage device and read a hotspot file from the nonvolatile storage device when receiving the request for reading the hotspot file, wherein the first storage unit and the second storage unit are integrally formed.

The functions of the determining unit 503, the copying unit 504 and the control unit 505 are the same with those of the determining unit 402, the copying unit 403 and the control unit 404 and a detailed description thereof is omitted herein.

Further, in the electronic device 500, the first storage unit 501 as a nonvolatile storage device and the second storage device 502 as volatile storage device are, for example, arranged on the same substrate and are connected to the electronic device, for example, by means of DDR, so that a single internal storage device can be formed integrally. At this time, the single internal storage device thus formed can assign the storage device address space uniformly in the operating system, and the non-volatile storage device can be distinguished from the volatile storage device according to the address space.

Therefore, when receiving the request for reading the hotspot files in the first storage unit 501, the operating system can directly address the nonvolatile storage device 501 as part of the internal storage device and read the hotspot file from the nonvolatile storage device 501. That is, for the hotspot files, only one stage to read the file from the internal storage device is required. Therefore, the operating speed of the electronic device can be significantly improved.

Therefore, according to the fifth embodiment of the present disclosure, specific files can be effectively read, thereby increasing the operating speed of the electronic device.

It should be noted that the above embodiments are merely used as examples, and the present disclosure is not limited to such examples, but can be variously changed.

Moreover, the above units are merely functional units used for implementing specific functions. In fact, each functional unit can be implemented by the CPU, storage device, hard disk, bus, etc. of the electronic device. Furthermore, each functional unit can be suitably connected to each other through internal buses or the like.

It should be noted that in the specification, the terms ‘comprise’, ‘include’ or any other variation thereof, are intended to cover a non-exclusive inclusion, such that a process, method, article, or device including a series of elements not only includes the elements, but also includes other elements not expressly listed, or further includes inherent elements for the process, method, article or device. In the case that there are no more constraints, elements defined by the statement ‘includes a/one . . . ’ do not exclude additional identical elements in the process, method, article, or device of the element.

Finally, it should be noted that the above-described series of processes does not only include the processing in the order of time series described herein, but also includes the processing that are performed in parallel or separately instead of in time series.

Through the above described embodiments, those skilled in the art can clearly understand that the present disclosure may be implemented by software plus a necessary hardware platform. Of course, it can also be implemented all by hardware. Based on this understanding, the whole or part of the contribution made by the technical solution of the present disclosure to the prior art may be embodied in the form of a software product. The computer software product may be stored in a storage medium, such as ROM (Read Only Storage device)/RAM (Random Access Storage device), a disk, an optical disk, etc., including several instructions for a computer device to perform each embodiment for the present disclosure or certain parts of the method of the embodiment.

The present disclosure has been described in detail above. The principles and embodiments of the present disclosure are described using specific examples and the description of the above embodiments is only used to facilitate understanding of the method of the disclosure and its core idea. Meanwhile, for those skilled in the art, according to the ideas of the present disclosure, there may be changes in specific embodiments and applications. Above all, the content of the present specification shall not be construed to limit the present disclosure.

1. A file reading method applied to an electronic device, the electronic device including a nonvolatile storage device as an internal storage device, the method comprising:
determining a specific file in the electronic device as a hotspot file according to a predetermined condition;
copying the determined hotspot file to the non-volatile storage device; and
directly addressing the non-volatile storage device and reading the hotspot file from the nonvolatile storage device when receiving a request for reading the hotspot file.

2. The file reading method according to claim 1, wherein the receiving a request for reading the hotspot file further comprises making the page cache pointer of the node directly point to the nonvolatile storage device address space.

3. The file reading method according to claim 1, wherein determining a specific file in the electronic device as a hotspot file according to a predetermined condition comprises determining whether the file is a hotspot file according to the file accessing frequency, wherein, the file is determined to be a hotspot file when the file accessing frequency is high.

4. The file reading method according to claim 1, wherein determining a specific file in the electronic device as a hotspot file according to a predetermined condition comprises determining a hotspot file according to the file type, wherein, the file is determined to be the hotspot file when the file is a system file.

5. The file reading method according to claim 4, further comprising when the electronic device is rebooted, directly reading the system file stored as the hotspot file in the non-volatile storage device so as to start quickly.

6. The file reading method according to claim 1, wherein the nonvolatile storage device is connected to the main board of the electronic device by means of the double data rate (“DDR”).

7. The file reading method according to claim 1, wherein the nonvolatile storage devices and the volatile storage device used as internal storage devices inside the electronic device are integrally formed.

8. The file reading method according to claim 1, wherein the specific file in the electronic device is maintained in an external storage device connected to the electronic device.

9. A storage device, comprising a first storage device, including a nonvolatile storage device configured to store hotspot files, wherein, when receiving a request for reading a hotspot file in the storage device, the nonvolatile storage device is directly addressed and the hotspot file is read from the non-volatile storage device.

10. The storage device according to claim 9, further comprising a second storage device, including a volatile storage device, wherein the first storage device and the second storage device are integrally formed.

11. An electronic device, comprising:
a first storage unit, including nonvolatile storage device and configured to store hotspot files of the electronic device;
a determining unit, configured to determine a specific file in the electronic device as a hotspot file according to a predetermined condition;
a copying unit, configured to copy the determined hotspot file to the nonvolatile storage unit; and
a control unit, configured to directly address the nonvolatile storage device and read the hotspot file from the nonvolatile storage device when receiving a request for reading the hotspot file.

12. The electronic device according to claim 11, further comprising a second storage unit, including a volatile storage device, wherein the first storage unit and the second storage unit are integrally formed.
